(19) United States
(12) Patent Application Publication
(10) Pub. No.: US 2023/0030868 A1
(43) Pub. Date: Feb. 2, 2023

(54) EXCHANGEABLE BALLOON GASTROJEJUNOSTOMY TUBE

(71) Applicant: Children's Hospital Medical Center of Akron, Akron, OH (US)

(72) Inventor: Reinaldo Garcia-Naveiro, Peninsula, OH (US)

(73) Assignee: Children's Hospital Medical Center of Akron, Akron, OH (US)

(21) Appl. No.: 17/874,495

(22) Filed: Jul. 27, 2022

Related U.S. Application Data
(60) Provisional application No. 63/227,065, filed on Jul. 29, 2021.

(51) Int. Cl. A61J 15/00

(52) U.S. Cl. CPC A61J 15/0015; A61J 15/0069; A61J 15/0042

(57) ABSTRACT

A gastrojejunostomy tube may comprise a jejunal tube, gastric tube, and a balloon tube. The jejunal tube may comprise a port at a proximal end and an opening at a distal end. The gastric tube may comprise a port at a proximal end and an opening at a distal end. The gastric tube may be operably, fixedly coupled with the jejunal tube to form a tubular portion of the gastrojejunostomy tube. The balloon tube may comprise a port at a proximal end and a balloon at a distal end, and may be sized to dispose the balloon in the stomach of the target patient. The balloon tube may be selectably removable from the tubular portion of the gastrojejunostomy tube such that the tubular portion remains in the target patient and the balloon tube is removed from the target patient and replaced by another balloon tube.

### RELATED APPLICATION DATA

This application claims priority to provisional application having Ser. No. 63/227,065, which was filed on Jul. 29, 2021, which is incorporated by reference herein in its entirety.

### BACKGROUND

Gastrojejunostomy (G-J) tubes are devices that allow patients to have enteral nutrition provided directly into their small bowel. They are typically used in patients who do not tolerate gastric feeding well, usually resulting from a gastric motility disorder. A G-J tube, which is often placed by either a surgeon, gastroenterologist, or an interventional radiologist, is commonly a long tube with three separate compartments: gastric tube, jejunal tube, and balloon tube. The gastric tube can serve to decompress the stomach, a balloon is in fluid communication with the balloon tube to allow for inflation and deflation of the balloon, and the jejunal tube can provide feeding access. The G-J tube typically enters the abdomen like a gastrostomy tube, except the distal end of the tube can extend in the jejunum. Once inside a patient, the balloon can become damaged, lose its integrity, and/or deflate requiring removal and/or replacement. Removing and replacing a balloon requires removal of the G-J tube from the patient's body followed by re-insertion of the G-J tube into the patient's body after replacing the balloon.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems are described herein for a gastrojejunostomy tube (G-J tube) with a replaceable balloon or a replaceable balloon tube. That is, for example, instead of removing a G-J tube from a patient, and replacing the entire G-J tube with a new one, merely the balloon may be detached and replaced or, alternatively, the balloon tube may be detached and replaced.

In one implementation a gastrojejunostomy tube may comprise a jejunal tube that may comprise a port at a proximal end and an opening at a distal end. The jejunal tube may be sized to dispose the opening at the distal end in a jejunum of a target patient. The gastrojejunostomy tube may further comprise a gastric tube that may comprise a port at a proximal end and an opening at a distal end. The gastric tube may be sized to dispose the opening at the distal end in a stomach of the target patient. The gastric tube may be operably, fixedly coupled with the jejunal tube to form a tubular portion of the gastrojejunostomy tube. Additionally, the gastrojejunostomy tube may further comprise a balloon tube that may comprise a port at a proximal end and a balloon at a distal end. The balloon tube may be sized to dispose the balloon in the stomach of the target patient. The balloon tube may be selectably removable from the tubular portion of the gastrojejunostomy tube such that the tubular portion remains in the target patient and the balloon tube is removed from the target patient and replaced by another balloon tube.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

FIG. 1 is a component diagram illustrating an example implementation of a gastrojejunostomy tube that can be separated into proximal and distal portions.

FIGS. 2A, 2B, and 2C are component diagrams illustrating various implementations of one or more portions of one or more systems described herein.

FIGS. 3A, 3B, and 3C are component diagrams illustrating various implementations of one or more portions of one or more systems described herein.

FIG. 4 is a flow diagram illustrating an example implementation of an example method for using a gastrojejunostomy tube.

FIG. 5 is a flow diagram illustrating an example implementation of an example method for manufacturing a gastrojejunostomy tube.

FIGS. 6A, 6B, and 6C are component diagrams illustrating various views of another example implementation of a gastrojejunostomy tube that can be separated into portions in accordance with this disclosure.

FIG. 7 is a component diagram illustrating a top view of one or more portions of the gastrojejunostomy tube of FIGS. 6A through 6C.

FIG. 8 is a component diagram illustrating one or more portions of the gastrojejunostomy tube of FIGS. 6A through 6C.

FIGS. 9A, 9B, and 9C are component diagrams illustrating cross-section views of various implementations of a portion of a component from FIG. 8.

FIGS. 10A and 10B are component diagrams illustrating one or more portions of the gastrojejunostomy tube of FIGS. 6A through 6C.

FIGS. 11A, 11B, 11C, and 11D are component diagrams illustrating various views of one or more portions of the gastrojejunostomy tube of FIGS. 6A through 6C.

FIGS. 12A and 12B are component diagrams illustrating one or more portions of the gastrojejunostomy tube of FIGS. 6A through 6C.

FIG. 13 is a component diagram illustrating one or more portions of the gastrojejunostomy tube of FIGS. 6A through 6C.

FIG. 14 is a flow diagram illustrating an example implementation of an exemplary method for using the gastrojejunostomy tube of FIGS. 6A through 6C.

FIG. 15 is a flow diagram illustrating an example implementation of an exemplary method for manufacturing the gastrojejunostomy tube of FIGS. 6A through 6C.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

In one aspect, a G-J tube can be devised that allows for removal and replacement of a balloon of the G-J tube, without removal of the entire G-J tube from the target patient. In this aspect, for example, a G-J tube can be devised for insertion through an access opening (e.g., stoma site) formed in the abdomen wall and stomach wall of a target patient. In one aspect, removal and replacement of the balloon of the G-J tube can be performed by a health care provider or caregiver. A patient would not need to undergo anesthesia to undergo the removal and replacement procedure. In this example, the G-J tube can be installed with the distal end disposed at the jejunum of the target patent, and the proximal end disposed outside of abdomen wall of the target patient, proximate the access opening. Further, a balloon port of the G-J tube can be used to inflate the balloon inside the target patient's stomach, to facilitate securing (e.g., at least temporarily) the G-J tube at a desired position. For example, the balloon can be inflated against the stomach wall, proximate the access opening, and hold the G-J tube in place in combination with a stop disposed outside the abdomen wall.

In this aspect, as an example, the balloon that was inflated inside the target patient's stomach may lose integrity and deflate, which can result in the G-J tube displacing from the desired location. In this example, a balloon that can no longer be used to hold the G-J tube at the desired location should be replaced. In order to replace the balloon, with prior G-J tubes, the entire tube is removed, and a new tube is inserted at the desired location. For example, G-J tubes are typically replaced using x-ray guidance, such as in a radiology department, to ensure that both the distal end of the gastric tube and the distal end of the jejunal tube are disposed in the desired location. Therefore, in this example, every few months, the target patient may be subjected to x-rays during replacement of a G-J tube, and an uncomfortable procedure, in order to replace a damaged balloon.

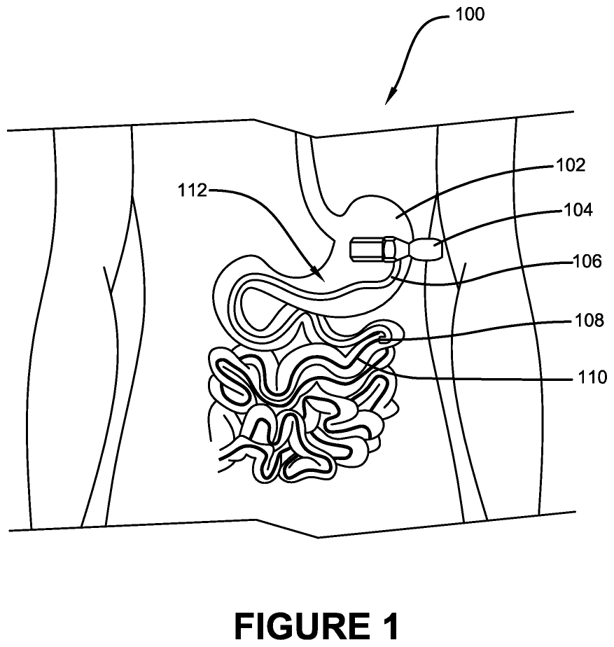

FIGS. 1, 2A, 2B, 2C, 3A, 3B, and 3C are component diagrams illustrating various implementations of an example G-J tube. The G-J tube 112, 200, 230, 260, 300, as described herein, may comprise a jejunal tube 202, 232, 262, a gastric tube 204, 234, 264, and a balloon tube 206, 236, 266. The G-J tube 112, 200, 230, 260, 300 has a proximal portion 302 and a distal portion 320.

In one implementation, in this aspect, a G-J tube 112, 200, 230, 260, 300, as described herein, may comprise a jejunal tube 202, 232, 262 comprising a port 306 at a proximal end that forms part of the proximal portion 302, and an opening 108, 318 at a distal end that forms part of the distal portion 320. The jejunal tube 202 can be sized (e.g., having a desired length) to dispose the opening 318 at the distal portion 320 in a jejunum 110 of a target patient. In this implementation, the jejunal tube 202, 232, 262 portion of the G-J tube 112, 200, 230, 260, 300 has a port 306 that is configured to be disposed outside 350 of the target patient, proximate an opening in the target patient's abdomen. The jejunal port 306 can be used to introduce products (e.g., nutrition, water, medicine, etc.) into the jejunal tube 202, 232, 262; and the jejunal opening 318 at the distal portion 320 can allow the introduced products to enter the jejunum 110 of the target patient. Further, for example, each patient can be of a different size, and a distance between the access opening in the target patient's abdomen and the jejunum 110 can also be different in length. Therefore, in this example, the jejunal tube 202, 232, 262 can be sized (e.g., having a desired length) to allow the port 306 to be disposed outside the abdomen 350, and the opening 318 to be appropriately disposed in the jejunum 110.

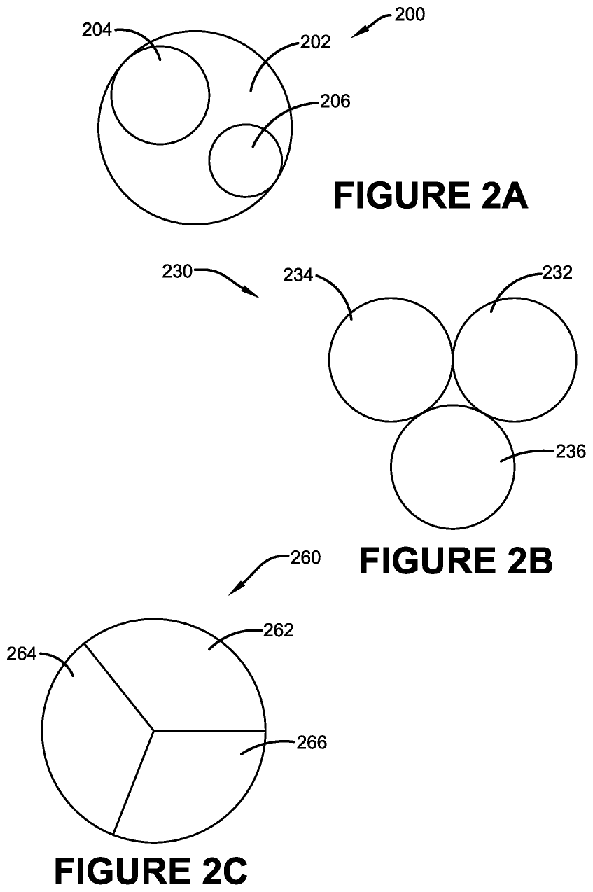

In this implementation, the G-J tube 112, 200, 230, 260, 300 can comprise a gastric tube 204, 234, 264, which comprises a port 308 at a proximal end that forms part of the proximal portion 302, and an opening 316 at a distal end that forms part of the distal portion 320. In this implementation, the gastric tube 204, 234, 264 can be sized to dispose the opening 316 at the distal portion 320 in a stomach 102 of the target patient. The gastric tube 204, 234, 264 can be operably, fixedly coupled with the jejunal tube 202, 232, 262. For example, the gastric tube 204, 234, 264 can be fixed to the jejunal tube 202, 232, 262 such that the respective tubes can be readily inserted into a target patient together, with one motion. As an example, as in FIG. 2B, the gastric tube 234 can be joined side-by-side with the jejunal tube 232; the gastric tube 264 and the jejunal tube 262 may comprise separate chambers of larger tube 260, as in FIG. 2C; or the gastric tube 204 may comprise a separate chamber disposed inside the jejunal tube 202 (e.g., or vice versa), as in 200 of FIG. 2A.

In this implementation, the gastric tube 204, 234, 264 portion of the G-J tube has a gastric port 308 that is configured to be disposed outside 350 of the target patient, proximate the opening in the target patient's abdomen. The gastric port 308 can be used to introduce products (e.g., nutrition, water, medicine, etc.) into the gastric tube 204, 234, 264; and the gastric opening 316 at the distal portion 320 can allow the introduced products to enter the stomach 102 of the target patient. As another example, the gastric port 308 can be used to decompress the stomach by draining (e.g., actively using a pump, or passively by opening the port) gas, fluid or other substances from the stomach. Further, for example, as each patient may be differently sized, the gastric tube 204, 234, 264 can also have different lengths to accommodate appropriately, such that the proximal gastric port 308 is disposed outside 350 the abdomen, and the distal gastric opening 316 is disposed in the stomach 352 of the target patient.

In this implementation, the G-J tube 112, 200, 230, 260, 300 can comprise a balloon tube 206, 236, 266 that comprises a port 310 at a proximal end that forms part of the proximal portion 302, and balloon 312 at a distal end that forms part of the distal portion 320. The balloon tube 206, 236, 266 can be sized to dispose the balloon 312 in the stomach 102 of the target patient. Further, the balloon tube 206, 236, 266 can be operably, fixedly coupled with the jejunal tube 202, 232, 262. As an example, the balloon tube 206, 236, 266 can be fixed to the jejunal tube 202, 232, 262 such that the respective tubes (e.g., jejunal, gastric and balloon) can be readily inserted into the target patient together, with one motion. As an example, the balloon tube 236 can be joined side-by-side with the jejunal tube 232; the balloon tube 266 and the jejunal tube 262 may comprise separate chambers of larger tube 260; or the balloon tube 206 may comprise a separate chamber disposed inside the jejunal tube 202 (e.g., or vice versa).

In this implementation, the balloon tube 206, 236, 266 portion of the G-J tube 112, 200, 230, 260, 300 has a balloon port 310 that is configured to be disposed outside 350 of the target patient, proximate the opening in the target patient's abdomen. The balloon port 310 can be used to introduce fluid (e.g., a gas or a liquid such as distilled/sterile water) into the balloon tube 206, 236, 266, which, in turn, can inflate the attached balloon 312 at the distal end of the balloon tube 206, 236, 266, in the patient's stomach 102. As an example, inflating the balloon 312 in the patient's stomach can provide for the G-J tube 300 to be appropriately secured inside the patient, as the balloon 312 mitigates movement of the G-J tube 300 to the outside of the patient. In some implementations, the balloon 312 partially wraps around the perimeter of a tubular portion of the G-J tube 300 leaving at least a portion, or a part of, the tubular portion of the G-J tube 300 uncovered by the balloon 312 (e.g., when the balloon is at least partially inflated) and exposed. In one implementation, a disk or other type of fastener can be secured on the G-J tube outside of the abdomen, to mitigate movement of the G-J tube to the inside of the patient. The balloon port 310 can be used to remove fluid (e.g., a gas or a liquid such as distilled/sterile water) from the balloon 312, to deflate the balloon 312, through the balloon tube 206, 236, 266, which may allow for removal of the G-J tube 300 from inside 352 the patient's stomach.

In this implementation, the G-J tube 300 can comprise a proximal portion 302 and a distal portion 320. The proximal portion 302 is selectably detachable from the distal portion 320 such that the distal portion 320 remains in the target patient 352 and the proximal portion 302 is removed from the patient. Further, the proximal portion 302 comprises the balloon tube 206, 236, 266, the port 308 of the gastric tube, and the port 306 of the jejunal tube, which may be respectively disposed in a port component 104, 304. For example, when it is time to replace the balloon 312 of the G-J tube 300 installed in a patient (e.g., the balloon is damaged, loses integrity, deflates, etc.) the proximal portion 302 can be detached from the distal portion 320. In this implementation, a replacement proximal portion of the gastrojejunostomy tube can be selectably, attached to the distal portion 320 remaining in 352 the target patient. That is, for example, the replacement proximal portion can be attached to the distal portion 320 while it remains inside the target patient.

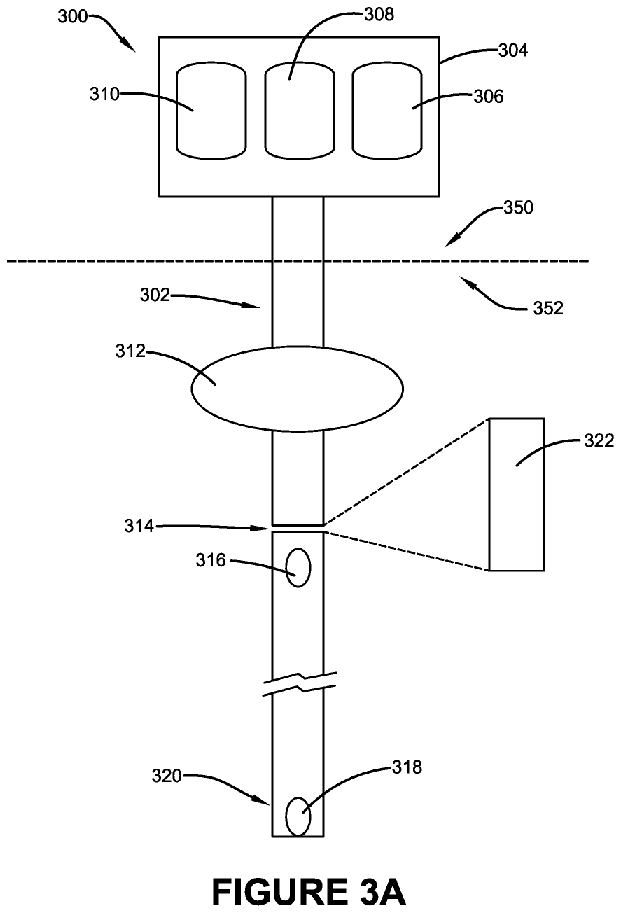

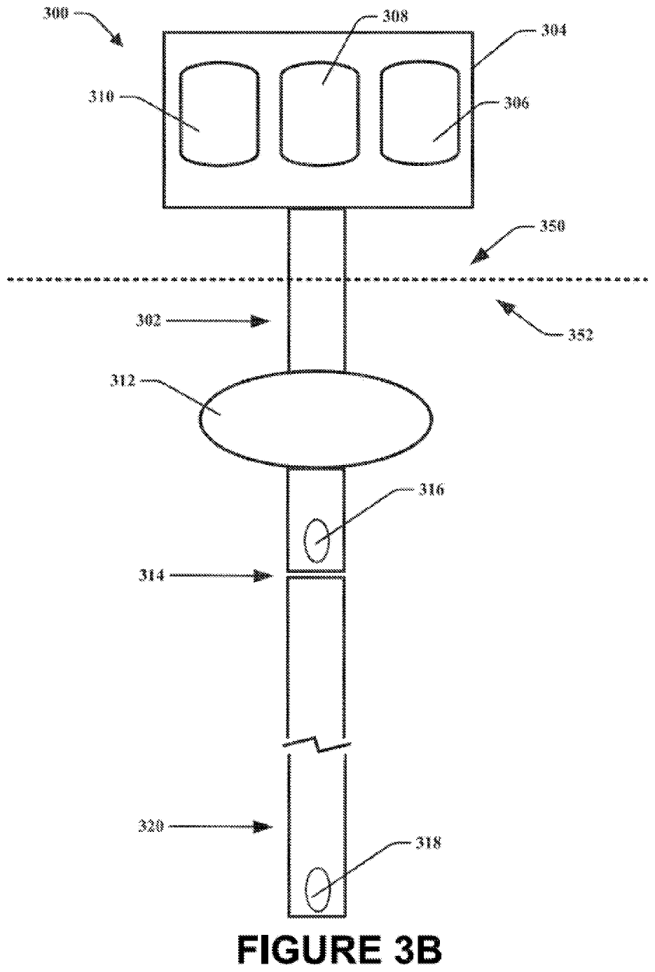

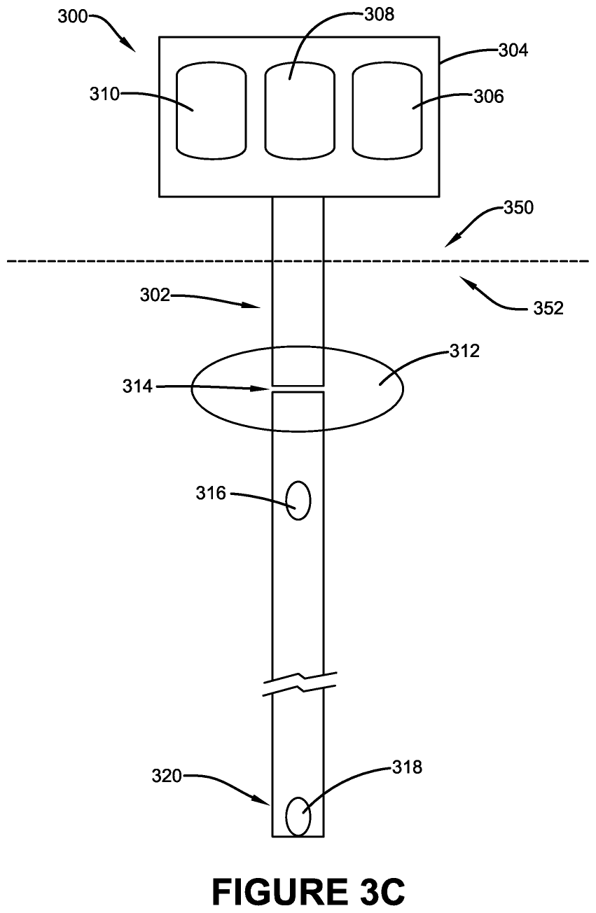

In one implementation, the distal portion 320 can comprise the distal portion of the jejunal tube, comprising the opening 318. In this way, for example, at least the jejunal tube of the G-J tube 300 can remain inside the patient 352. This can mitigate the use of x-ray assisted insertion, as the jejunal tube portion can be merely moved back into its desired location after the replacement proximal portion is attached. In another implementation, the distal portion 320 of the G-J tube 300 can comprise the distal portion of the gastric tube, comprising the gastric opening 316. In this way, at least the distal portion 320 of both the jejunal tube distal portion and the gastric tube distal portion of the G-J tube 300 can remain inside the patient during replacement of the proximal portion. As one example, the proximal portion 302 can comprise the balloon tube, including the balloon port 310 and balloon 312. In this example, merely the balloon tube is detached from the distal portion 320, as in FIG. 3A, and a replacement balloon tube can be attached to the distal portion 320. In this example, the attached, new balloon tube can be reinserted through the access opening, and the balloon can be inflated to hold the G-J tube in the desired location.

In one implementation, the G-J tube 300 described herein, can comprise a connection 314 that is disposed between the proximal portion 302 and the distal portion 320 of the gastrojejunostomy tube 300. In this implementation, the connection can provide a secure, fluid coupling between the proximal portion 302 and the distal portion 320. As an example, the connection 314 can comprise a type of leur lock design, an S-connector, a quick connector, or some other connection that can be used to fluidly couple tubes together in a suitable connection, inside a patient. That is, for example, the connection 314 can comprise two portions that are respectively, operably engaged with either the proximal portion 302 of the G-J tube 300, or the distal portion 320 of the G-J tube 300. In this example, the respective portions of the connection 314 can be selectably, fixedly engaged with each other to form the fluid coupling (e.g., substantially leak-free) between the portions of the G-J tube 300.

In one implementation, the connection 314 can be disposed distally from the balloon 312 and proximally from the opening 316 at the distal end of the gastric tube, as in FIG. 3A. That is, for example, the connection 314 point is between the balloon 312 and opening 316 of the gastric tube. In this example, the proximal portion 302 can comprise the balloon tube 206, including the balloon 312 and balloon port 310, the gastric port 308, and the jejunal port 306, disposed in the port component 104, 304. In this example, the distal portion 320 of the G-J tube 300 can comprise the distal portion of the gastric tube and the distal portion of the jejunal tube. In one implementation, as in FIG. 3B, the connection 314 can be disposed distally from the distal end of the gastric tube and proximally from the opening 318 at the distal end of the jejunal tube. That is, for example, the connection 314 point is disposed between the opening 316 of the gastric tube and the opening 318 of the distal portion of the jejunal tube. In this example, the proximal portion 302 comprises the balloon tube, gastric tube, and jejunal port 306; and the distal portion 320 of the G-J tube comprises the distal portion of the jejunal tube.

In one implementation, the connection 314 can be disposed within an inner lumen of the balloon 312, as in FIG. 3C. That is, for example, the connection 314 can be formed such that the connection 314 point is not exposed to the stomach 102. In this implementation, the connection portions that couple together to form the fluid coupling may not be exposed to stomach fluids that may compromise the integrity of the connection components (e.g., break down due to exposure to acids).

In one implementation, the G-J tube 112, 300 can comprise one or more extension tubes 322. In this implementation, the extension tube 322 can comprise a portion of the jejunal tube. In this implementation, the extension tube 322 can be sized (e.g., lengthwise) to extend the distance between the port 306 and the opening 318 of the jejunal tube. In one example, the extension tube 322 may comprise at least a portion of the gastric tube, to extend the distance between the gastric port 308 and gastric opening 316. Further, the extension tube can be selectably attachable to the G-J tube 300 between the proximal portion 302 and a distal portion 320 of the G-J tube 300. That is, for example, the length of the jejunal tube can be adjusted by attaching or removing an extension tube 322 to the jejunal tube portion of the G-J tube at the connection 314. As an example, the extension tube 322 can comprise a coupling portion that complements one of the portions of the connection 314, to selectably, fixedly attach to the G-J tube 300 to form a fluid coupling.

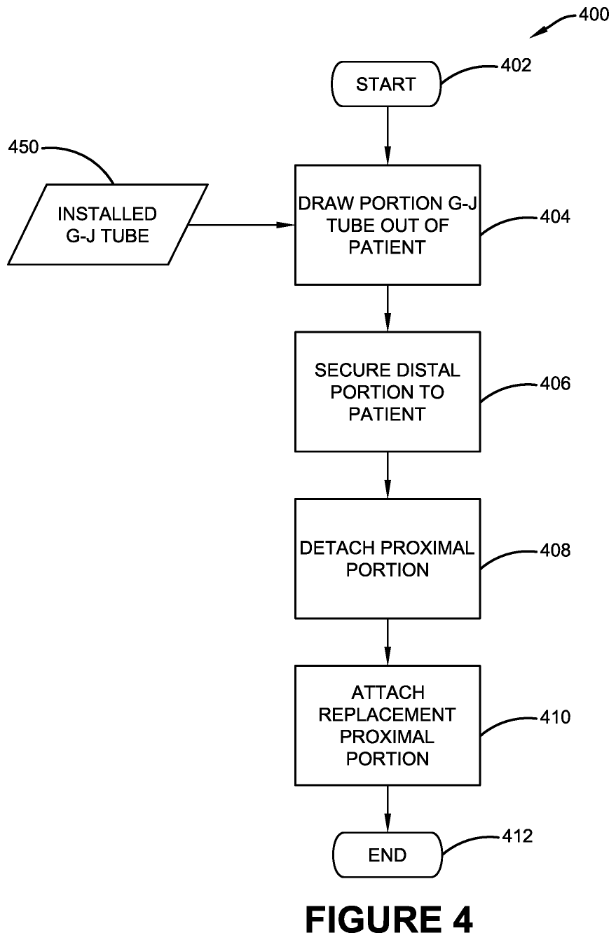

A method may be devised for using a gastrojejunostomy tube (G-J tube). That is, for example, a method can be devised for using the G-J tube described herein. FIG. 4 is a flow diagram illustrating an example implementation of an example method 400 for using a gastrojejunostomy tube. The exemplary method 400 begins at 402. At 404, a portion of a G-J tube 450 installed in a patient can be drawn from the target patient. In this implementation, the G-J tube can comprise: a jejunal tube comprising a port at a proximal end and an opening at a distal end, and sized to dispose the opening at the distal end in a jejunum of the target patient; a gastric tube comprising a port at a proximal end and an opening at a distal end, and sized to dispose the opening at the distal end in a stomach of the target patient, the gastric tube operably, fixedly coupled with the jejunal tube; and a balloon tube comprising a port at a proximal end and balloon at a distal end, and sized to dispose the balloon in the stomach of the target patient, the balloon tube operably, fixedly coupled with the jejunal tube. Further, in this implementation, the gastrojejunostomy tube can comprise a proximal portion and a distal portion with a connection disposed there between, the proximal portion can be selectably detachable from the distal portion at the connection, and the proximal portion can comprise the balloon tube, the port of the gastric tube, and the port of the jejunal tube.

In this exemplary method, at 406, the distal portion of the gastrojejunostomy tube can be secured to the patient such that the connection is accessible. That is, for example, the G-J tube 450 can be drawn (e.g., pulled) out of the patient at least to a point where a clinician (e.g., or other qualified person) can access the connection to appropriately detach the proximal portion from the distal portion. Further, for example, the distal portion can be secured to the patient, such as using a clamp, fastener, tape, or other suitable device, so that the distal portion does not go back into the patient at least until a replacement proximal portion is attached.

In one implementation, the drawing of the portion of the gastrojejunostomy tube from the target patient can comprise drawing the gastrojejunostomy tube to expose the connection. In one implementation, the connection can be disposed distally from the balloon and proximally from the opening at the distal end of the gastric tube; distally from the distal end of the gastric tube and proximally from the opening at the distal end of the jejunal tube; or within an inner lumen of the balloon.

In this exemplary method, at 408, the proximal portion can be detached from the distal portion at the connection of the G-J tube 450. That is, for example, the two portions of the connection can be uncoupled to detach the proximal portion from the distal portion. As one example, using a leur lock, one portion can be unscrewed from the other portion; using a quick connector, one portion can be decoupled by deactivating the locking mechanism, from the other portion. In one implementation, detaching of the proximal portion from the distal portion at the connection can comprise detaching the proximal portion that comprises the gastric tube. In one implementation, detaching of the proximal portion from the distal portion at the connection can comprise detaching at the connection wherein the connection is disposed within an inner lumen of the balloon.

In this exemplary method, at 410, a replacement proximal portion can be attached to the distal portion at the connection while the distal portion remains in the target patient. That is, for example, a connection portion on the replacement proximal portion can be coupled to the other portion of the connection on the distal portion. Having attached the replacement proximal portion, the exemplary method 400 ends at 412.

In one implementation, after the replacement proximal portion is attached, the G-J tube can be reinserted into the target patient, at least to the desired location. Further, in one implementation, the balloon of the replacement proximal portion can be inflated using the balloon port, to secure the gastrojejunostomy tube in the target patient. As one example, a replacement disk or other fastener can be installed on the G-J tube outside of the abdomen, at the access port, to help secure the G-J tube in position.

In one implementation, a method of using a G-J tube can comprise selectably attaching an extension tube to the gastrojejunostomy tube between the proximal portion and a distal portion. In this implementation, the extension tube can comprise a portion of the jejunal tube, and the extension tube can be sized (e.g., lengthwise) to extend the distance between the port and the opening of the jejunal tube. In one implementation, the method of using a G-J tube can comprise selectably attaching an extension tube wherein the extension tube comprises a portion of the gastric tube, and wherein the extension tube is sized to extend the distance between the port and the opening of the gastric tube. That is, for example, the extension tube can be used to extend the length of the jejunal tube and/or the gastric tube.

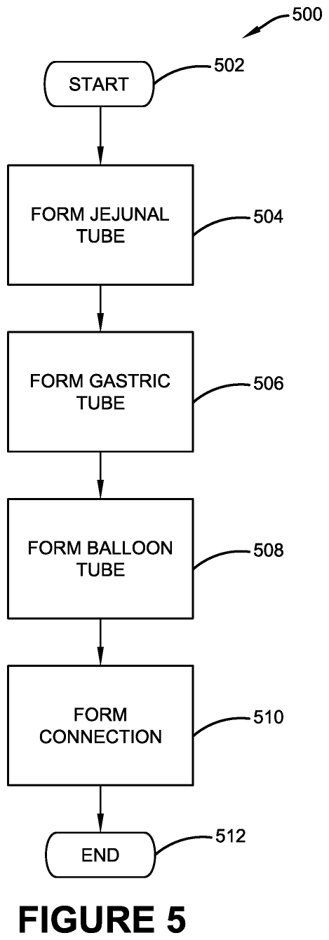

A method of manufacturing a gastrojejunostomy tube (G-J tube) can be devised. FIG. 5 is a flow diagram illustrating an example implementation of an example method 500 for manufacturing a gastrojejunostomy tube. The exemplary method 500 begins at 502. At 504, manufacturing the G-J tube can comprise forming a jejunal tube that comprises a port at a proximal end and an opening at a distal end. In this implementation, the jejunal tube can be sized to dispose the opening at the distal end in a jejunum of a target patient. Further, in this exemplary method, at 506, a gastric tube can be formed that comprises a port at a proximal end and an opening at a distal end. The gastric tube can be sized to dispose the opening at the distal end in a stomach of the target patient. Additionally, the gastric tube can be formed to be operably, fixedly coupled with the jejunal tube.

In this implementation of the exemplary method of manufacture, at 506, a balloon tube can be formed that comprises a port at a proximal end and balloon at a distal end. The balloon tube can be sized to dispose the balloon in the stomach of the target patient. Further, the balloon tube can be formed to be operably, fixedly coupled with the jejunal tube. Additionally, the G-J tube can be formed with a proximal portion and a distal portion. In this implementation, the proximal portion can be formed to be selectably detachable from the distal portion such that the distal portion can remain in the target patient and the proximal portion can be removed from the patient. The proximal portion can also be formed to comprise the balloon tube, the port of the gastric tube, and the port of the jejunal tube. In this implementation, the G-J tube can be formed such that a replacement proximal portion of the G-J tube can be selectably, attached to the distal portion remaining in the target patient.

In one implementation, at 510 of the exemplary method of manufacture, a connection can be formed between the proximal portion and a distal portion of the gastrojejunostomy tube. In this implementation, the connection can provide a secure, fluid coupling between the proximal portion and a distal portion. In one implementation, the forming of the connection can comprise disposing the connection: distally from the balloon and proximally from the opening at the distal end of the gastric tube; distally from the distal end of the gastric tube and proximally from the opening at the distal end of the jejunal tube; or within an inner lumen of the balloon.

In one implementation, the exemplary method of manufacture can comprise forming an extension tube that comprises a portion of the jejunal tube. In this implementation, the extension tube can be selectably attachable to the gastrojejunostomy tube between the proximal portion and a distal portion of the gastrojejunostomy tube. Further, the extension tube can be sized to extend the distance between the port and the opening of the jejunal tube.

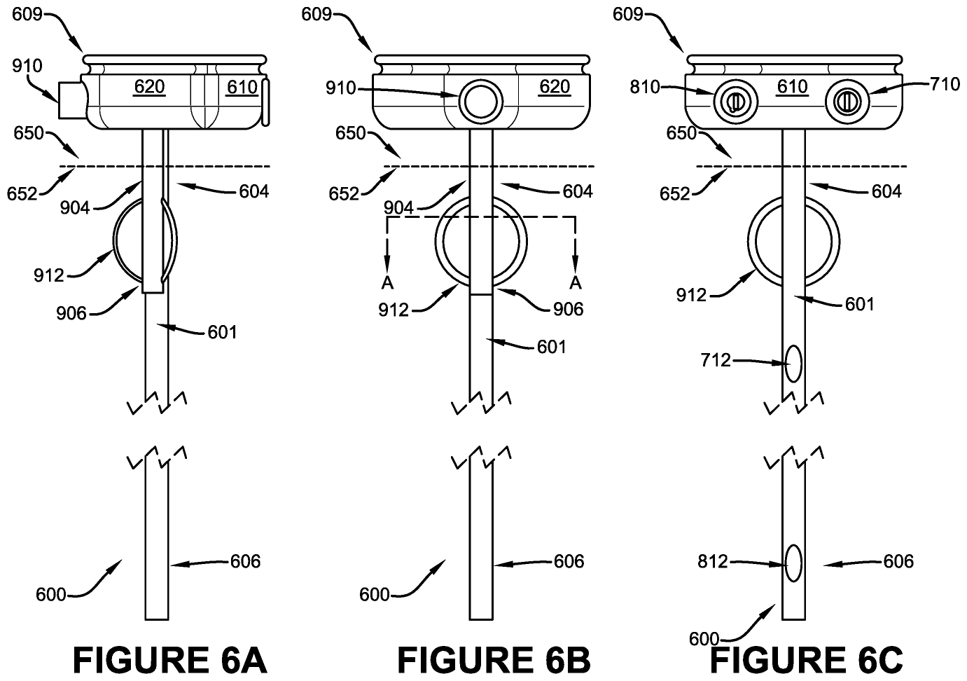

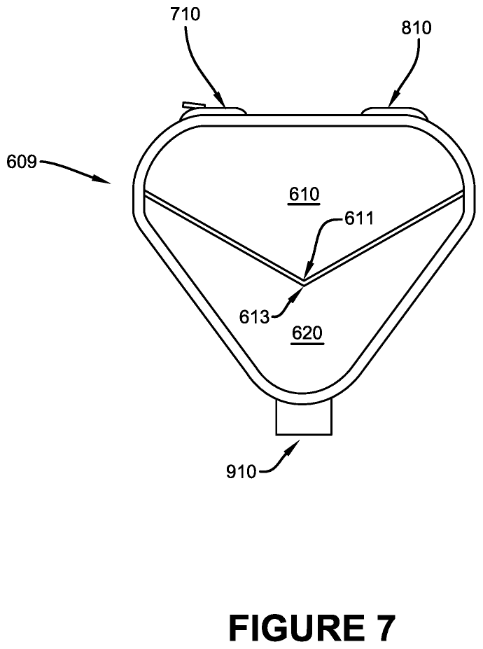

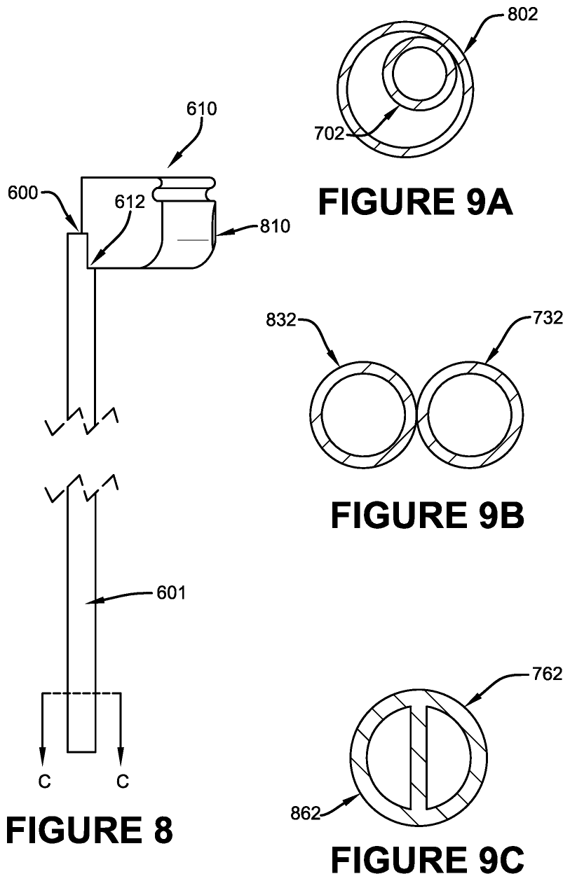

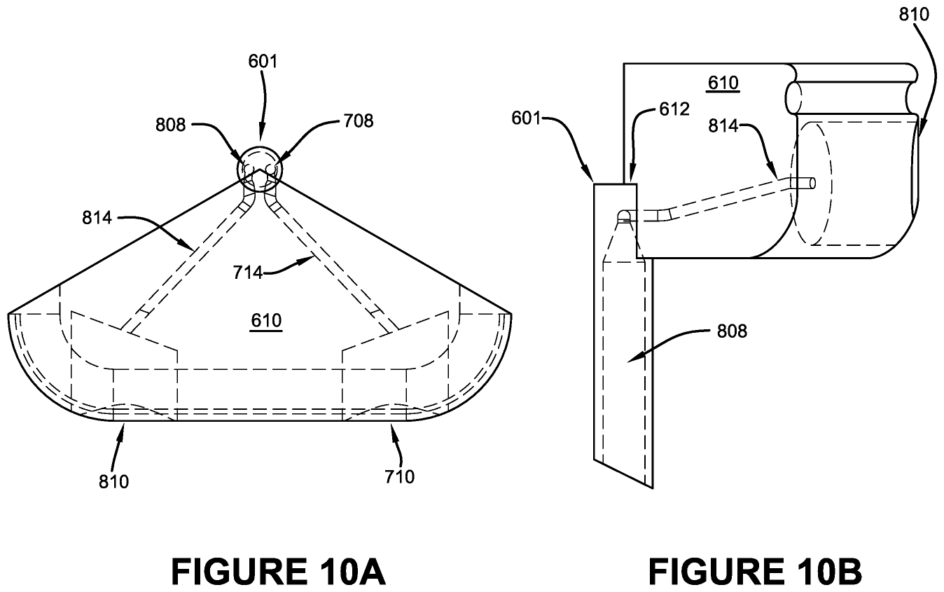

FIGS. 6A-6C, 7, 8, 9A-9C, 10A-10B, 11A-11D, 12A-12B, and 13 are component diagrams illustrating an implementation of an example G-J tube 600 as well as one or more portions thereof in accordance with this disclosure. The G-J tube 600 may comprise a selectably removable balloon tube 902 that allows for removal and replacement of the balloon tube 902 without removal of the entire G-J tube 600 from a target patient, for a purpose such as to exchange/replace a balloon 912 of the balloon tube 902.

The G-J tube 600 may comprise a gastric tube 702, 732, 762, a jejunal tube 802, 832, 862, and the selectably removable balloon tube 902. The G-J tube 600 comprises a proximal portion 604, which includes the proximal ends 704, 804, 904 of the gastric, jejunal, and balloon tubes respectively, and a distal portion 606, which includes the distal ends 706, 806, 906 of the gastric, jejunal, and balloon tubes respectively, as will be described in more detail below. In some implementations, the G-J tube 600 may comprise a housing 609 that is configured to hold and/or retain one or more portions of one or more of the gastric tube 702, 732, 762, the jejunal tube 802, 832, 862, and the selectably removable balloon tube 902. In some implementations, the housing 609 may comprise a first port component 610 and a second port component 620.

In some implementations, the G-J tube 600 may comprise the jejunal tube 802, 832, 862, which can comprise a jejunal port 810 at a proximal end 804 and a jejunal opening 812 at a distal end 806. The jejunal tube 802, 832, 862 can be sized (e.g., having a desired length) to dispose the jejunal opening 812 at the distal end 806 in a jejunum 110 of the target patient. In this implementation, the jejunal tube 802, 832, 862 portion of the G-J tube 600 has the jejunal port 810 configured to be disposed outside 650 of the target patient, proximate an opening in the target patient's abdomen.

The jejunal port 810 is generally in fluid communication with a jejunal lumen 808 of the respective jejunal tube 802, 832, 862. In some implementations, a jejunal channel 814 may connect the jejunal port 810 to the jejunal tube 802, 832, 862 to establish fluid communication between the jejunal port 810 and the jejunal lumen 808 of the respective jejunal tube 802, 832, 862. As an example, the jejunal port 810 can be used to introduce products (e.g., nutrition, water, medicine, etc.) into the jejunal lumen 808 of the jejunal tube 802, 832, 862; and the jejunal opening 812 at the distal end 806 can allow the introduced products to enter the jejunum 110 of the target patient. Further, for example, each patient can be of a different size, and a distance between the access opening in the target patient's abdomen and the jejunum 110 can also be different in length. Therefore, in this example, the jejunal tube 802, 832, 862 can be sized (e.g., having a desired length) to allow the jejunal port 810 to be disposed outside 650 of the abdomen, and the jejunal opening 812 at the distal end 806 to be appropriately disposed in the jejunum 110.

In some implementations, the G-J tube 600 may comprise the gastric tube 702, 732, 762, which can comprise a gastric port 710 at a proximal end 704 and a gastric opening 712 at a distal end 706. The gastric tube 702, 732, 762 can be sized to dispose the gastric opening 712 at the distal end 706 in a stomach 102 of the target patient. In this implementation, the gastric tube 702, 732, 762 portion of the G-J tube 600 has the gastric port 710 configured to be disposed outside 650 of the target patient, proximate the opening in the target patient's abdomen.

The gastric port 710 is generally in fluid communication with a gastric lumen 708 of the respective gastric tube 702, 732, 762. In some implementations, a gastric channel 714 may connect the gastric port 710 to the gastric tube 702, 732, 762 to establish fluid communication between the gastric port 710 and the gastric lumen 708 of the respective gastric tube 702, 732, 762. As an example, the gastric port 710 can be used to introduce products (e.g., nutrition, water, medicine, etc.) into the gastric lumen 708 of the gastric tube 702, 732, 762; and the gastric opening 712 at the distal end 706 can allow the introduced products to enter the stomach 102 of the target patient. As another example, the gastric port 710 can be used to decompress the stomach by draining (e.g., actively using a pump, or passively by opening the port) gas, fluid or other substances from the stomach. Further, for example, as each patient may be differently sized, the gastric tube 702, 732, 762 can also have different lengths to accommodate appropriately, such that the gastric port 710 at the proximal end 704 is disposed outside 650 of the abdomen, and the gastric opening 712 at the distal end 706 is disposed inside 652 the stomach of the target patient.

In some implementations, the gastric tube 702, 732, 762 can be operably, fixedly coupled with the jejunal tube 802, 832, 862 to form a tubular portion 601 of the G-J tube 600. For example, the gastric tube 702, 732, 762 can be fixedly coupled to the jejunal tube 802, 832, 862 such that the respective tubes can be readily inserted into the target patient together, with one motion. As an example, the gastric tube 702 may comprise a separate chamber disposed inside the jejunal tube 802 (e.g., or vice versa), as in FIG. 9A; the gastric tube 732 can be joined side-by-side with the jejunal tube 832, as in FIG. 9B; or the gastric tube 762 and the jejunal tube 862 may comprise separate chambers of a larger G-J tube, as in FIG. 9C.

In some implementations, the G-J tube 600 may comprise the balloon tube 902, which may comprise a balloon port 910 at a proximal end 904 and a balloon 912 disposed at a distal end 906. The balloon tube 902 can be sized to dispose the balloon 912 in the stomach 102 of the target patient. The balloon tube 902 is a separate, distinct component that is selectably removable from the G-J tube 600. In some implementations, the balloon tube 902 can be operably, removably coupled with the tubular portion 601 of the G-J tube 600. As an example, the balloon tube 902 can be removably coupled to the tubular portion 601 of the G-J tube 600 such that the respective tubes (e.g., jejunal, gastric, and balloon) can be readily inserted into the target patient together, with one motion. At the same time, the balloon tube 902 remains selectably removable from the tubular portion 601 of the G-J tube 600 such that the balloon tube 902 can be readily detached from the tubular portion 601 for reasons such as to exchange/replace the balloon 912 by replacing the balloon tube 902. In this example, the balloon tube 902, once detached from the tubular portion 601 of the G-J tube 600, can be removed from the target patient without removing the remainder of the G-J tube 600 (e.g., the tubular portion 601 comprising the gastric and jejunal tubes) from the target patient.

In some implementations, the balloon tube 902 can comprise a body that defines a recess 914 for receiving at least part of the tubular portion 601 (e.g., a proximal portion 604) of the G-J tube 600 therein. The recess 914 can have dimensions that complement the dimensions of the tubular portion 601 of the G-J tube 600 in order for the recess 914 to accommodate at least part of the tubular portion 601 of the G-J tube 600 within the recess 914 of the balloon tube 902. It will be appreciated that the tubular portion 601 is not limited to any particular shape, but generally the tubular portion 601 has a smooth, curved outer surface without sharp corners which could potentially irritate internal tissue of the target patient. In some non-limiting examples, the tubular portion 601 comprises a curved, or tubular, body with a circular or elliptical cross-section. In these implementations, the balloon tube 902 has a curved body that defines a recess 914 with dimensions that complement the curved body of the tubular portion 601 so that the recess 914 can accommodate at least part of the curved body of the tubular portion 601 within the recess 914.

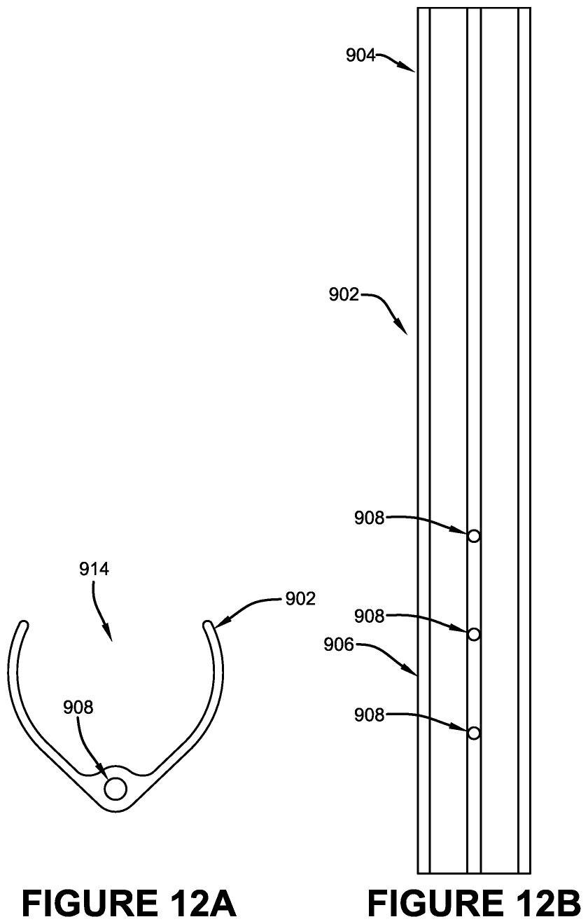

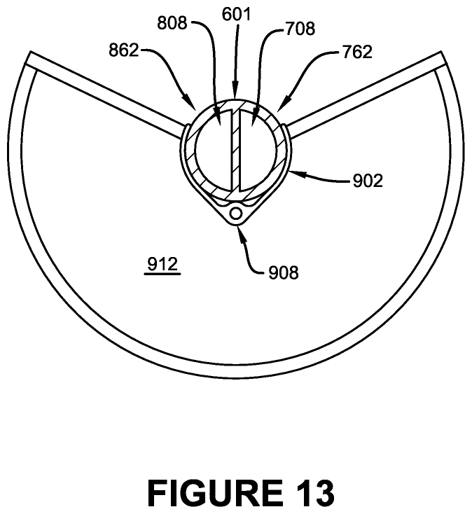

FIGS. 12A, 12B, and 13 show the balloon tube 902 comprising a recess 914 that is defined by the curved, cylindrical body of the balloon tube 902. The recess 914 has dimensions configured to receive at least part of the curved tubular portion 601 of the G-J tube 600 within the recess 914.

In some implementations, the balloon tube 902 body can partially extend around, or wrap around, the perimeter of the tubular portion 601 of the G-J tube 600 that is disposed in the recess 914 to selectably, removably couple the balloon tube 902 to the tubular portion 601 of the G-J tube 600. In these implementations, the balloon tube 902 body partially extends around, or wraps around, the perimeter of the tubular portion 601 such as, for example, the part of the tubular portion 601 that is disposed within the recess 914. But, it will be appreciated that the balloon tube 902 body does not extend around the entire perimeter of the tubular portion 601 and at least part of the tubular portion 601 is not covered by the balloon tube 902 body and is exposed. In some implementations, the balloon tube 902 body has a curved-shape that is configured to wrap around at least part of the curved, tubular portion 601 of the G-J tube 600 to removably couple the balloon tube 902 to the tubular portion 601 of the G-J tube 600.

The balloon tube 902 can remain removably coupled to the tubular portion 601 of the G-J tube 600 with the tubular portion 601 retained within the recess 914 through frictional engagement (i.e. direct physical contact) between the surface of the balloon tube 902 body and the surface of the tubular portion 601 body.

As an example, FIG. 13 shows the G-J tube 600 comprising a tubular portion 601 having a circular cross section. In this example, the balloon tube 902 does not extend around the entire perimeter, here the circumference, of the tubular portion 601 of the G-J tube 600. Instead, the balloon tube 902 partially wraps around the circumference of the tubular portion 601 of the G-J tube 600 such that at least part of the tubular portion 601 is not covered by the body of the balloon tube 902 and is exposed. For G-J tubes comprising a tubular portion having a cross-section other than a circle, the same principle applies in that the balloon tube partially extends around (e.g., wraps around) the perimeter of the tubular portion of the G-J tube thereby leaving at least part of the perimeter of the tubular portion uncovered by the balloon tube and exposed.

The balloon tube 902 can be configured to partially wrap around, or extend around, the perimeter of the tubular portion 601 of the G-J tube 600 (e.g., in a hugging fashion) rather than to completely wrap around the perimeter of the tubular portion 601 to provide benefits such as: a simple and effective means to manually attach/detach the balloon tube 902 to the tubular portion 601 of the G-J tube 600 and a safe and reliable, operable coupling between the balloon tube 902 and the tubular portion 601 of the G-J tube 600.

In some implementations, the balloon tube 902 can comprise a generally u-shaped body having two curved arms extending from a midpoint of the body and defining the recess 914, as shown in FIGS. 12A and 12B. The balloon tube 902 body can define the balloon lumen 908 of the balloon tube 902 with the balloon lumen 908 being disposed in the balloon tube 902 body at or near the midpoint. Fluid can be supplied to the balloon tube 902 and conveyed to the balloon 912 via the balloon lumen 908 in order to inflate the balloon 912. In these implementations, the two curved arms can be configured to extend around part of the curved tubular portion 601 of the G-J tube 600 disposed within the recess 914. The arms of the balloon tube 902 can cooperate to apply spring force to the G-J tube 600 (e.g., a restoring force) to removably couple the balloon tube 902 to the tubular portion 601 of the G-J tube 600 with the tubular portion 601 disposed within the recess 914. The balloon 912, when inflated, partially wraps around (e.g., partially extends around) the perimeter of the tubular portion 601 of the G-J tube 600 with part of the tubular portion 601 not covered by the balloon 912.

As an example, FIG. 13 shows the G-J tube 600 comprising a balloon 912 that does not extend around the entire perimeter (or circumference for a tubular portion 601 having a circular cross-section) of the tubular portion 601. Instead, the balloon 912 partially wraps around the circumference of the tubular portion 601 of the G-J tube 600 such that at least part of the tubular portion 601 is not covered by the balloon 912 and is exposed. For G-J tubes comprising tubular portions having a cross-section other than a circle, the same principle applies in that the balloon of the balloon tube partially extends around (e.g., wraps around) the perimeter of the tubular portion of the G-J tube thereby leaving at least part of the tubular portion of the G-J tube uncovered by the balloon and exposed.

It has been discovered that it is not necessary for the balloon 912 to extend around, or wrap around, the entire perimeter of the tubular portion 601 of the G-J tube 600 to effectively secure the G-J tube 600 inside of the stomach wall. Instead, the balloon 912 can partially wrap around the perimeter of the tubular portion 601 and, when the balloon 912 is at least partially inflated, the balloon 912 can adequately secure the G-J tube 600 to the inside of the stomach.

This design offers technical advantages such as material reduction and space reduction, which can simplify the entry and removal of the G-J tube in a target patient's abdomen. As an example, a smaller balloon tube 902 can be used to support the balloon 912 because both the balloon tube 902 and balloon 912 may partially extend around the perimeter of the tubular portion 601 of the G-J tube 600 rather than wrapping around the entire perimeter of the tubular portion 601 of the G-J tube 600. Moreover, this configuration may provide a balloon 912 that requires less fluid to inflate and less material to make, and provides the opportunity to incorporate balloons having different structure/shapes.

In this implementation, the balloon tube 902 of the G-J tube 600 comprises a balloon port 910 that is configured to be disposed outside 650 of the target patient, proximate the opening in the target patient's abdomen. The balloon port 910 is generally in fluid communication with the balloon lumen 908 of the respective balloon tube 902. In some implementations, a balloon channel 916 connects the balloon port 910 to the balloon tube 902 to establish fluid communication between the balloon port 910 and the balloon lumen 908 of the respective balloon tube 902. The balloon port 910 can be used to introduce fluid (e.g., a gas or a liquid such as distilled/sterile water) into the balloon lumen 908 of the balloon tube 902, which, in turn, can inflate the attached balloon 912 at the distal end 906 of the balloon tube 902, in the patient's stomach 102. As an example, inflating the balloon 912 in the patient's stomach can provide for the G-J tube 600 to be safely and reliably secured inside 652 the patient, as the balloon 912 mitigates movement of the G-J tube 600 to the outside 650 of the patient. The balloon port 910 can be used to remove fluid (e.g., a gas or a liquid such as distilled/sterile water) from the balloon 912 via the balloon tube 902 to deflate the balloon 912, which may allow for removal of the G-J tube 600 from inside 652 the patient's stomach.

In some implementations, the G-J tube 600 can comprise the housing 609 comprising the first port component 610 and the second port component 620. The first port component 610 can comprise a body having a size and shape configured to house the gastric port 710 and the jejunal port 810. In some implementations, the connection between the gastric port 710 and the gastric channel 714 and the connection between the jejunal port 810 and the jejunal channel 814 each may be respectively disposed in the first port component 610. The first port component 610 can be any suitable size and shape that permits the first port component 610 to interface and engage with a second port component 620 as well as at least part of the G-J tube 600 (e.g., the tubular portion 601 of the G-J tube 600) to establish fluid communication with the G-J tube 600.

The first port component 610 can further comprise a receiving slot 612 disposed on the body of the first port component 610. The receiving slot 612 can have a size and shape configured to accommodate at least part of the proximal portion 604 of the G-J tube 600 (e.g., the tubular portion 601 of the G-J tube 600) in the receiving slot 612. Fluid communication between the gastric port 710 and the gastric tube 702, 732, 762 and fluid communication between the jejunal port 810 and the jejunal tube 802, 832, 862 can be established when at least part of the tubular portion of the G-J tube 600 is disposed in the receiving slot 612 of the first port component 610. As an example, the gastric channel 714 can connect the gastric port 710 to the gastric tube 702, 732, 762 and the jejunal channel 814 can connect the jejunal port 810 to the jejunal tube 802, 832, 862 when at least part of the tubular portion 601 of the G-J tube 600 is disposed within (e.g., inserted into) the receiving slot 612. At least part of the G-J tube 600, specifically at least part of the tubular portion 601, can be secured and retained in the receiving slot 612 of the first port component 610 through frictional engagement of the surfaces (e.g., press fit, interference fit, etc.) or adhesive. Thus, at least part of the tubular portion 601 of the G-J tube 600 can be secured in the receiving slot 612 of the first port component 610 on a temporary basis (e.g., removably attached) or permanent basis (e.g., glued or molded together).

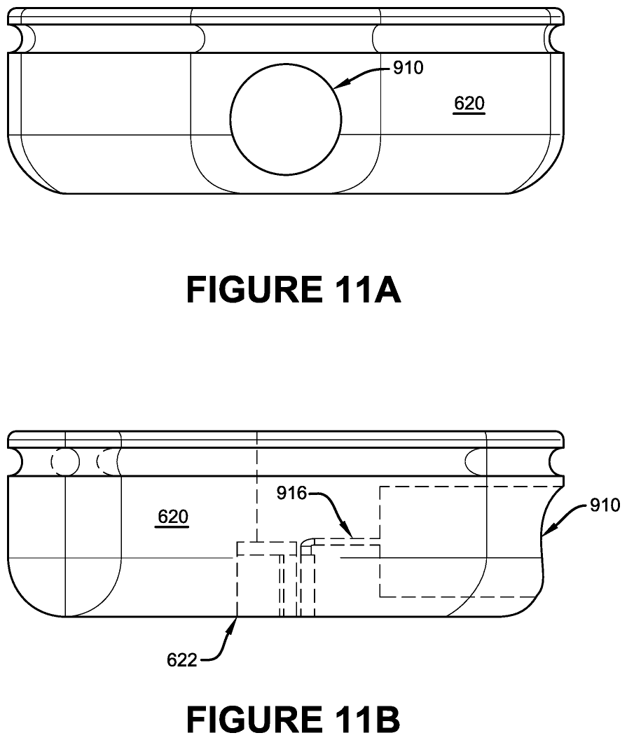

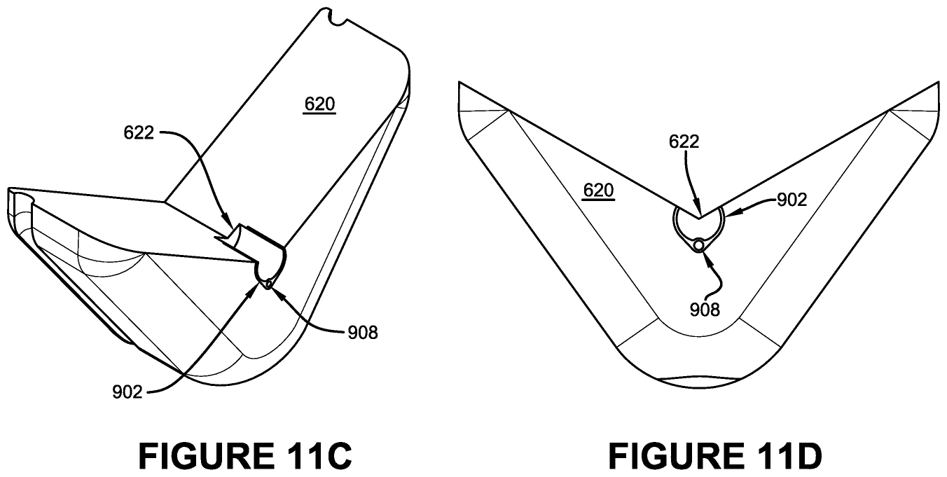

In some implementations, the G-J tube 600 can comprise the second port component 620. The second port component 620 can comprise a body having a size and shape configured to house the balloon port 910. In some implementations, the connection between the balloon port 910 and the balloon channel 916 (e.g., FIG. 11B), if present, may be disposed in the second port component 620. The body of the second port component 620 can be configured to selectably engage and interface with the first port component 610.

In some implementations, the first and second port components 610, 620 are complementary structures that facilitate coupling between the first port component 610 and the second port component 620 when arranged in a specific orientation. In some implementations, the complementary structures can comprise a surface protrusion 611 on the first port component 610 and a complementary receiving recess 613 formed in the second port component 620. In these implementations, the surface protrusion 611 is configured to be inserted into the complementary receiving recess 613. In other implementations, the first and second port components 610, 620 have bodies designed as complementary shapes to facilitate coupling between the first port component 610 and the second port component 620 in a specific orientation. As an example, the body of the first port component 610 can comprise a triangular extension (e.g., convex feature) that can be inserted into a triangular depression (e.g., concave feature) formed in the second port component 620, the first port component 610 having a substantially smooth surface that is configured to engage and cooperate with a complementary, substantially smooth surface of the second port component 620.

The second port component 620 can further comprise a receiving slot 622 disposed on the body of the second port component 620. The receiving slot 622 can have a size and shape configured to accommodate at least part of the balloon tube 902, in particular the proximal end 904 of the balloon tube 902, in the receiving slot 622. Fluid communication between the balloon port 910 and the balloon tube 902 can be established when the balloon tube 902 is disposed in the receiving slot 622 of the second port component 620. As an example, the balloon channel 916 can connect the balloon port 910 to the balloon tube 902 when the proximal end 904 of the balloon tube 902 is disposed within the receiving slot 622. Additionally, at least part of the tubular portion 601 of the G-J tube 600 can be disposed in the recess 914 of the balloon tube 902 while the balloon tube 902 is disposed within the receiving slot 622. In this example, the remainder of the tubular portion 601 is disposed within the receiving slot 612 of the first port component 610 when the first port component 610 is operably coupled to the second port component 620. It should be readily apparent that the complimentary structures and/or shapes of the first port component 610 (e.g., triangular extension) and the second port component 620 (e.g., triangular depression) allow the first port component 610 and the second port component 620 to couple in one particular arrangement (e.g., one specific orientation). This can be beneficial to help align the receiving slot 612 of the first port component 610 with the receiving slot 622 of the second port component 620 when the first and second port components 610, 620 are operably coupled. The aligned receiving slots 612, 622 can cooperate to retain the tubular portion 601 of the G-J tube 600 and the balloon tube 902 in the receiving slots 612, 622 of the first and second port components 610, 620.

In some implementations, the first port component 610 and the second port component 620 can be complimentary shapes that permit coupling between the first port component 610 and the second port component 620 when arranged in a specific orientation, thereby aligning the first and second port components 610, 620. Once the first port component 610 and the second port component 620 are properly aligned, the first port component 610 and second port component 620 can be secured together, or mated, so as to facilitate cooperation between the first and second port components 610, 620 to retain the tubular portion 601 of the G-J tube 600 and the balloon tube 902 in the receiving slots 612, 622 of the first and second port components 610, 620.

The first port component 610 and the second port component 620 can be mated or fastened together in any suitable manner such as, but not limited to, interlocking surface features on the first and second port components 610, 620 and/or cooperating mating surfaces on the first and second port components 610, 620. As an example, interlocking or mating features can facilitate a snap fit or click fit that engages when a threshold pressure is exerted on the first and second port components 610, 620 arranged in a specific orientation for coupling (i.e., oriented for coupling). As another example, the interlocking or mating features may comprise tracks that guide engagement between the first and second port components 610, 620 until achieving a locking engagement. Secure attachment between the first and second port components 610, 620 can also be established by inserting a pin through the first and second port components 610, 620, via application of adhesive tape, a hook and loop fastener comprising hooks disposed on the first port component 610 and loops disposed on the second port component 620 or vice versa, etc. It should be readily apparent that a releasable fastening means is advantageous to secure the first port component 610 to the second port component 620.

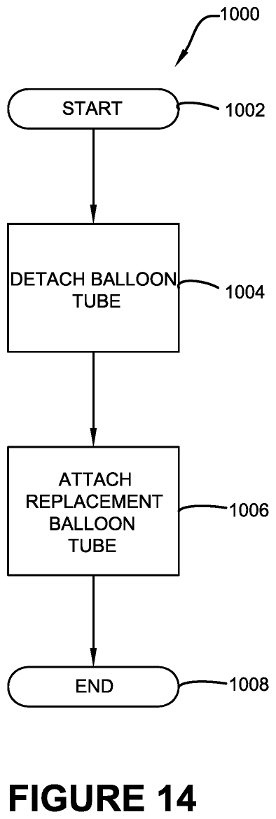

A method may be devised for using a G-J tube. That is, for example, a method can be devised for using the G-J tube described herein. FIG. 14 is a flow diagram illustrating an example implementation of an exemplary method for using the G-J tube (e.g., 600 in FIGS. 6A-6C). The exemplary method 1000 begins at 1002 with the G-J tube 600 disposed within a target patient. In this implementation, the G-J tube 600 can comprise: a jejunal tube comprising a jejunal port at a proximal end and a jejunal opening at a distal end, and sized to dispose the jejunal opening at the distal end in a jejunum of the target patient; a gastric tube comprising a gastric port at a proximal end and a gastric opening at a distal end, and sized to dispose the gastric opening at the distal end in a stomach of the target patient, the gastric tube operably, fixedly coupled with the jejunal tube to form a tubular portion of the G-J tube; and a balloon tube comprising a balloon port at a proximal end and a balloon at a distal end, and sized to dispose the balloon in the stomach of the target patient, the balloon tube being selectably removable from the tubular portion of the G-J tube such that the tubular portion remains in the target patient and the balloon tube is selectably removed from the target patient and replaced. At 1004, the balloon tube is selectably detached from the tubular portion of the G-J tube 600. In some implementations, the balloon can be selectably removed from the balloon tube and replaced.

In this implementation, for example, the balloon tube can be accessed and selectably detached from the tubular portion, such as by a clinician (e.g., or other qualified person) to exchange/replace the balloon tube and/or the balloon, with only minimal or slight drawing (i.e., pulling out) of the remaining G-J tube (e.g., the tubular portion comprising the jejunal tube and the gastric tube) from the patient. In some implementations, a clinician can access the balloon tube and selectably detach the balloon tube from the tubular portion without drawing (i.e., pulling out) any of the remaining G-J tube (e.g., the tubular portion comprising the jejunal tube and the gastric tube) from the patient. This aspect of the G-J tube 600 is particularly beneficial because drawing or pulling the G-J tube from the patient by a certain threshold amount can change the positioning of the jejunal tube in the small intestine which can cause injury to patient tissue and/or can require complete removal and replacement of the G-J tube in the patient. The balloon tube, once detached from the tubular portion of the G-J tube 600, can be removed from the target patient (i.e., after the balloon has been deflated) while the rest of the G-J tube (e.g., the tubular portion comprising the gastric and jejunal tubes) remains substantially in place in the target patient.

In this exemplary method, at 1006, a replacement balloon tube, which comprises the balloon port and inflatable balloon, can be attached to the G-J tube 600. In this implementation, the replacement balloon tube can be removably coupled to the tubular portion of the G-J tube 600 while the tubular portion of the G-J tube remains substantially in place in the target patient. That is, for example, a recess of the balloon tube, which is defined by the balloon tube body, can receive at least part of the tubular portion of the G-J tube within the recess with the balloon tube body partially extending around a perimeter of the tubular portion. Having attached the replacement balloon tube, the exemplary method 1000 ends at 1008.

In one implementation, after the replacement balloon tube is removably coupled to the tubular portion of the G-J tube at 1006, the balloon of the replacement balloon tube can be inflated using the balloon port, to secure the G-J tube 600 in the target patient.

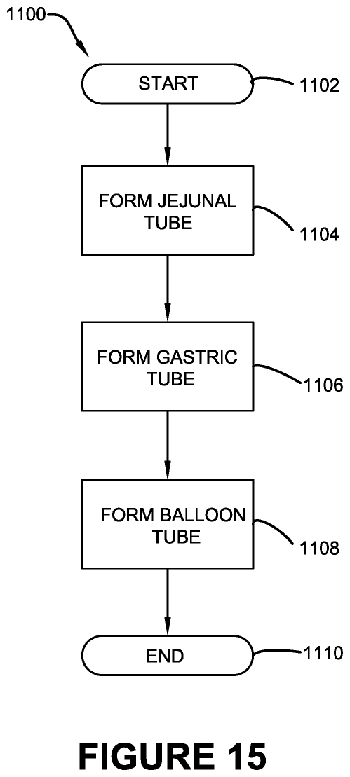

A method of manufacturing a G-J tube can be devised. FIG. 15 is a flow diagram illustrating an example implementation of an exemplary method 1100 for manufacturing a G-J tube. The exemplary method 1100 begins at 1102. At 1104, manufacturing the G-J tube (e.g., 600 in FIGS. 6A-6C) can comprise forming a jejunal tube that comprises a jejunal port at a proximal end and a jejunal opening at a distal end. In this implementation, the jejunal tube can be sized to dispose the jejunal opening at the distal end in a jejunum of a target patient. Further, in this exemplary method, at 1106, a gastric tube can be formed that comprises a gastric port at a proximal end and a gastric opening at a distal end. The gastric tube can be sized to dispose the gastric opening at the distal end in a stomach of the target patient. Additionally, the gastric tube can be formed to be operably, fixedly coupled with the jejunal tube to form a tubular portion of the G-J tube.

In this implementation of the exemplary method of manufacture, at 1108, a balloon tube can be formed that comprises a balloon port at a proximal end and an inflatable balloon at a distal end. The balloon tube can be sized to dispose the balloon in the stomach of the target patient. Further, the balloon tube can be formed to be selectably removable from the tubular portion of the G-J tube such that the tubular portion can remain in the target patient while the balloon tube is removed from the target patient. The replacement balloon tube can be configured to facilitate its removable coupling to the tubular portion of the G-J tube. As an example, the balloon tube can comprise a body that defines a recess for receiving at least part of the tubular portion of the G-J tube within the recess. In particular, the balloon tube body is configured to partially wrap around a perimeter of the tubular portion of the G-J tube so that the balloon tube can be removably coupled to the tubular portion of the G-J tube with part of the tubular portion not covered by the balloon tube body. Having formed the balloon tube, the exemplary method 1100 ends at 1110.

In some implementations, after forming the balloon tube at 1108, the exemplary method of manufacturing the G-J tube can further comprise forming a first port component and forming a second port component. The first and second port components can be complementary structures that are configured to interface and operably couple in a specific orientation. Together, the first and second port components can be configured to collectively house the jejunal port and the gastric port and to accommodate at least a part of the tubular portion of the G-J tube and at least part of the balloon tube.

In summary, the new and improved G-J tube 600 described herein comprises a separate and distinct balloon tube 902 that is selectably removable from the G-J tube 600 so that the balloon tube 902 can be detached from the G-J tube 600 without requiring removal of the G-J tube 600 from inside the patient's stomach. For example, when it is time to exchange or replace the balloon 912 of the G-J tube 600 installed in a patient (e.g., the balloon is damaged, loses integrity, deflates, etc.) the balloon tube 902 simply can be detached from the tubular portion 601 of the G-J tube 600. Additionally, the configuration of the balloon tube 902 provides versatility to the G-J tube 600 because the balloon 912 only has to partially wrap around the perimeter of the tubular portion 601 of the G-J tube 600 permitting different types and shapes of balloons 912 to be implemented in the G-J tube 600 disclosed herein.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, At least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Furthermore, the claimed subject matter may be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device, carrier or media. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A gastrojejunostomy tube, comprising:
a jejunal tube comprising a jejunal port at a proximal end and a jejunal opening at a distal end, and sized to dispose the jejunal opening at the distal end in a jejunum of a target patient;
a gastric tube comprising a gastric port at a proximal end and a gastric opening at a distal end, and sized to dispose the gastric opening at the distal end in a stomach of the target patient, the gastric tube operably, fixedly coupled with the jejunal tube to form a tubular portion of the gastrojejunostomy tube; and
a balloon tube comprising a balloon port at a proximal end and a balloon at a distal end, and sized to dispose the balloon in the stomach of the target patient, the balloon tube being selectably removable from the tubular portion of the gastrojejunostomy tube such that the tubular portion remains in the target patient and the balloon tube is removed from the target patient and replaced by another balloon tube.

2. The gastrojejunostomy tube of claim 1, wherein the balloon partially wraps around a perimeter of the tubular portion of the gastrojejunostomy tube with part of the tubular portion not covered by the balloon.

3. The gastrojejunostomy tube of claim 1, wherein the balloon tube comprises a body that defines a recess for receiving at least part of the tubular portion of the gastrojejunostomy tube within the recess, wherein the balloon tube body partially wraps around a perimeter of the tubular portion of the gastrojejunostomy tube to removably couple the balloon tube to the tubular portion of the gastrojejunostomy tube with part of the tubular portion not covered by the balloon tube body.

4. The gastrojejunostomy tube of claim 3, wherein the balloon tube has a curved body that defines the recess for receiving at least part of a curved tubular portion of the gastrojejunostomy tube within the recess, wherein the curved body of the balloon tube is configured to partially wrap around the perimeter of the curved tubular portion to removably couple the balloon tube to the tubular portion of the gastrojejunostomy tube.

5. The gastrojejunostomy tube of claim 1, further comprising a first port component that is configured to:
house the jejunal port and the gastric port; and
accommodate at least part of the tubular portion of the gastrojejunostomy tube in a receiving slot disposed on the first port component.

6. The gastrojejunostomy tube of claim 5, further comprising a second port component that is configured to:
selectably interface and engage with the first port component;
house the balloon port; and
accommodate at least part of the balloon tube in a receiving slot disposed on the second port component.

7. The gastrojejunostomy tube of claim 6, wherein:
at least part of the tubular portion of the gastrojejunostomy tube is disposed in the receiving slot of the first port component providing fluid communication between the gastric port and the gastric tube and fluid communication between the jejunal port and the jejunal tube;
at least part of the balloon tube is disposed in the receiving slot of the second port component providing fluid communication between the balloon port and the balloon tube; and
at least part of the tubular portion of the gastrojejunostomy tube is disposed within a recess defined by the balloon tube with the balloon tube partially wrapped around a perimeter of the tubular portion of the gastrojejunostomy tube to removably couple the balloon tube to the tubular portion of the gastrojejunostomy tube.

8. The gastrojejunostomy tube of claim 6, wherein the first port component is operably coupled to the second port component.

9. The gastrojejunostomy tube of claim 8, wherein the first and second port components are complementary structures that facilitate coupling between the first and second port components in a specific orientation.

10. The gastrojejunostomy tube of claim 9, wherein the complementary structures comprise one or of:
a surface protrusion on the first port component and a complementary receiving recess formed in the second port component, the surface protrusion configured to be inserted into the complementary receiving recess.

11. The gastrojejunostomy tube of claim 8, wherein the first port component is operably coupled to the second port component by one or more of:
a snap fit or click fit that engages when a threshold pressure is exerted on first and second port components which are oriented for coupling;
tracks on each of the first and second port components that guide engagement between the first and second port components until the tracks achieve locking engagement;
a pin inserted through the first and second port components;
adhesive tape applied to at a least a portion of the first and second port components; or
a hook and loop fastener comprising hooks disposed on the first port component and loops disposed on the second port component, or vice versa.

12. A gastrojejunostomy tube, comprising:
a jejunal tube comprising a jejunal port at a proximal end and a jejunal opening at a distal end, and sized to dispose the jejunal opening at the distal end in a jejunum of a target patient;
a gastric tube comprising a gastric port at a proximal end and a gastric opening at a distal end, and sized to dispose the gastric opening at the distal end in a stomach of the target patient, the gastric tube operably, fixedly coupled with the jejunal tube to form a tubular portion of the gastrojejunostomy tube; and
a balloon tube comprising a balloon port at a proximal end and a balloon at a distal end, the balloon tube being sized to dispose the balloon in the stomach of the target patient, the balloon tube being selectably removable from the tubular portion of the gastrojejunostomy tube such that the tubular portion remains in the target patient and the balloon tube is removed from the target patient and replaced by another balloon tube;
wherein the balloon partially wraps around a perimeter of the tubular portion of the gastrojejunostomy tube with part of the tubular portion not covered by the balloon.

13. The gastrojejunostomy tube of claim 12, wherein the balloon tube comprises a body that defines a recess for receiving at least part of the tubular portion of the gastrojejunostomy tube within the recess, wherein the balloon tube body partially wraps around a perimeter of the tubular portion disposed within the recess to removably couple the balloon tube to the tubular portion of the gastrojejunostomy tube with part of the tubular portion not covered by the balloon tube body.

14. The gastrojejunostomy tube of claim 13, wherein the balloon tube has a curved body which defines the recess for receiving at least part of a curved tubular portion of the gastrojejunostomy tube within the recess, wherein the curved body of the balloon tube is configured to partially wrap around the perimeter of the curved tubular portion to removably couple the balloon tube to the tubular portion of the gastrojejunostomy tube.

15. The gastrojejunostomy tube of claim 12, further comprising a housing comprising a first port component operably coupled to a second port component, wherein:
the first port component is configured to:
house the jejunal port and the gastric port; and
accommodate at least part of the tubular portion of the gastrojejunostomy tube in a receiving slot disposed on the first port component; and
the second port component is configured to:
selectably interface and engage with the first port component;
house the balloon port; and
accommodate at least part of the balloon tube in a receiving slot disposed on the second port component.

16. The gastrojejunostomy tube of claim 15, wherein the first port component and the second port component have complementary shapes that facilitate coupling between the first and second port components in a specific orientation.

17. The gastrojejunostomy tube of claim 16, wherein operable coupling of the first and second port components aligns the receiving slots of the respective first and second port components such that the receiving slots cooperate to retain:
at least part of the tubular portion of the gastrojejunostomy tube within the receiving slot of the first port component to provide fluid communication between the gastric port and the gastric tube and fluid communication between the jejunal port and the jejunal tube;
at least part of the balloon tube within the receiving slot of the second port component to provide fluid communication between the balloon port and the balloon tube; and
at least part of the tubular portion of the gastrojejunostomy tube within a recess defined by the balloon tube with the balloon tube partially wrapped around a perimeter of the tubular portion of the gastrojejunostomy tube to removably couple the balloon tube to the tubular portion of the gastrojejunostomy tube.

18. The gastrojejunostomy tube of claim 15, wherein the first port component is operably coupled to the second port component by one or more of:
a snap fit or click fit that engages when a threshold pressure is exerted on first and second port components which are oriented for coupling;
tracks on each of the first and second port components that guide engagement between the first and second port components until the tracks achieve locking engagement;
a pin inserted through the first and second port components;
adhesive tape applied to at a least a portion of the first and second port components; or
a hook and loop fastener comprising hooks disposed on the first port component and loops disposed on the second port component, or vice versa.

19. A gastrojejunostomy tube, comprising:
a jejunal tube comprising a jejunal port at a proximal end and a jejunal opening at a distal end, and sized to dispose the jejunal opening at the distal end in a jejunum of a target patient and the jejunal port at the proximal end outside the target patient;
a gastric tube comprising a gastric port at a proximal end and a gastric opening at a distal end, and sized to dispose the gastric opening at the distal end in a stomach of the target patient and the gastric port at the proximal end outside the target patient, the gastric tube operably, fixedly coupled with the jejunal tube to form a tubular portion of the gastrojejunostomy tube; and
a balloon tube comprising a balloon port at a proximal end and a balloon at a distal end, and sized to dispose the balloon in the stomach of the target patient and the balloon port at the proximal end outside the target patient, the balloon tube being selectably removable from the tubular portion of the gastrojejunostomy tube such that the tubular portion remains in the target patient and the balloon tube is removed from the target patient and replaced by another balloon tube.

20. The gastrojejunostomy tube of claim 19, wherein the balloon partially wraps around a perimeter of the tubular portion of the gastrojejunostomy tube with part of the tubular portion not covered by the balloon.

21. The gastrojejunostomy tube of claim 19, wherein the balloon tube comprises a body that defines a recess for receiving at least part of the tubular portion of the gastrojejunostomy tube within the recess, wherein the balloon tube body partially wraps around a perimeter of the tubular portion disposed within the recess to removably couple the balloon tube to the tubular portion of the gastrojejunostomy tube with part of the tubular portion not covered by the balloon tube body.

22. The gastrojejunostomy tube of claim 21, wherein the balloon tube comprises a generally u-shaped body with two curved arms extending from a midpoint of the body and defining the recess for receiving at least part of a curved tubular portion of the gastrojejunostomy tube within the recess, wherein the two curved arms are configured to partially wrap around the perimeter of the curved tubular portion disposed within the recess, the two curved arms cooperating to apply a spring force to the tubular portion to removably couple the balloon tube to the tubular portion of the gastrojejunostomy tube.

23. The gastrojejunostomy tube of claim 19, further comprising a housing comprising a first port component operably coupled to a second port component with the first port component affixed to the second port component;
wherein at least part of the tubular portion of the gastrojejunostomy tube is disposed in a receiving slot of the first port component providing fluid communication between the gastric port and the gastric tube and fluid communication between the jejunal port and the jejunal tube;
wherein at least part of the balloon tube is disposed in a receiving slot of the second port component providing fluid communication between the balloon port and the balloon tube; and
wherein at least part of the tubular portion of the gastrojejunostomy tube is disposed within a recess defined by the balloon tube with the balloon tube partially wrapped around a perimeter of the tubular portion of the gastrojejunostomy tube to removably couple the balloon tube to the tubular portion of the gastrojejunostomy tube.
